(19) United States
(12) Patent Application Publication
(10) Pub. No.: US 2004/0061655 A1
(43) Pub. Date: Apr. 1, 2004

(54) ENVIRONMENTALLY SENSITIVE MULTI-FREQUENCY ANTENNA

(76) Inventors: Ian J. Forster, Chelmsford (GB); Patrick F. King, Glen Ellyn, IL (US)

Correspondence Address: WITHROW & TERRANOVA, P.L.L.C., P.O. BOX 1287, CARY, NC, 27512, US

(21) Appl. No.: 10/213,769

(22) Filed: Aug. 7, 2002

(51) Int. Cl. G08B 13/14

(52) U.S. Cl. 343/767; 340/572.7; 340/10.41

(57) ABSTRACT

A transponder is secured to a substrate with a temperature sensitive adhesive. A pair of tabs acts as a first antenna to allow the transponder to respond to interrogation at a first frequency, and a slot in the substrate acts as a second antenna to allow the transponder to respond to interrogation at a second frequency. When the transponder is secured to the substrate with the temperature sensitive adhesive, the transponder only operates at the second frequency. The temperature sensitive adhesive melts when exposed to a temperature above a predetermined threshold, causing the transponder to decouple from the slot and operate at the first frequency. An alternate embodiment functions similarly for pressure sensing.

### FIELD OF THE INVENTION

The present invention relates to a transponder that is sensitive to changes in the environment such as temperature such that the transponder operates at a different frequency when a temperature threshold has been exceeded.

### BACKGROUND OF THE INVENTION

It is often necessary to monitor the location and movement of materials within a distribution center or manufacturing facility. One method of tracking the materials is to attach wireless communication devices, such as radio frequency identification (RFID) transponders, to the materials to be tracked. The transponder may include an identification device indicative of the contents of the containers that carry such materials.

To facilitate communication with the transponders, interrogators may be positioned throughout the distribution or manufacturing facility to receive signals transmitted from the transponders. The signals may be passed to a central control system that monitors and records the applicable information. The central control system can also send information to the interrogators to send to the transponders for response and/or to be stored in the transponders' memories.

The information communicated by the containers in the system may be used for a number of reasons. For example, statistical analysis may be made of the materials to maintain an accurate inventory, production flow rates, and other production standards. Additionally, the identification devices may include specific information about the materials housed within the containers, including date of manufacture, place of manufacture, type of product within the container, temperature of the container and ambient air, temperature of the contents of the container, pressure of the container, and the like. It is also possible that the transponders may be used outside of the manufacturing facility for tracking or the like.

The transponders typically have some type of antenna arrangement to communicate information about the containers to the interrogators. It is sometimes a problem to provide antennas where the wireless communication device underlying the transponder is small or is required to be placed in a contained area. The length of the antenna must be tailored to specific frequencies at which the transponder is designed to operate.

The assignee of the present invention is also the assignee of U.S. patent application Ser. No. 09/536,334, filed 25 Mar. 2000, which is hereby incorporated by reference in its entirety, which details a transponder coupled to a slot antenna for a variety of purposes. To save time in the design stage of future products having transponders, more design options are desirable. Further, some products may be pressure or temperature sensitive such that it is desirable to know if the product has been exposed to a temperature above or a pressure below a predetermined threshold.

### SUMMARY OF THE INVENTION

The present invention couples a transponder to a slot to form a slot antenna operating at a first frequency with a temperature sensitive adhesive. If the transponder is exposed to a temperature above a predetermined threshold, the adhesive dissolves and the transponder decouples from the slot. The tabs with which the transponder had been coupled to the slot form a dipole antenna operating at a second frequency. A control system may determine if the container on which the transponder is mounted has been subjected to a temperature above a predetermined threshold by failing to detect a response with an interrogator at the first frequency but detecting a response at the second frequency.

In an alternate embodiment, the tabs that form the dipole antenna are securely adhered to a portion of the substrate forming the slot. A predefined deformation is imparted to the tabs such that absent the adhesive, the tabs no longer couple to the slot antenna while remaining affixed to the substrate and the dual frequency functionality is achieved.

In another alternate embodiment, a foam member may be positioned between the tabs of the transponder and the substrate such that if a low pressure situation occurs, the foam expands, effectively decoupling the transponder from the substrate. In the decoupled state, the transponder operates with the tab antenna and not the slot antenna.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a transponder according to an exemplary embodiment of the present invention;

FIG. 2 illustrates the transponder of FIG. 1 secured to a slot to form a slot antenna;

FIGS. 3A and 3B illustrate an alternate embodiment of the present invention with the transponder secured to a substrate forming a slot;

FIG. 4 provides a flow chart embodying the process of using the present invention;

FIGS. 5A and 5B illustrate an alternate pressure sensing embodiment of the present invention; and

FIG. 6 illustrates an alternate to the embodiment of FIGS. 5A and 5B.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

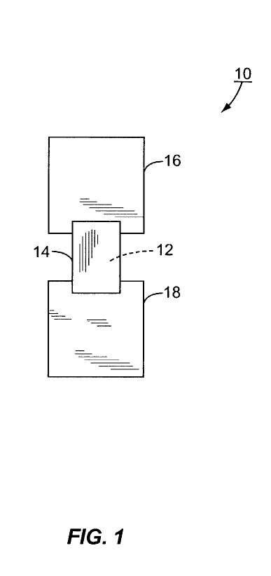

FIG. 1 illustrates an exemplary transponder 10 such as is well suited for use with the present invention. Wireless communication circuitry 12 is positioned in a chip 14 such as the “MICROINSERT” or “ONETAG” chips sold by the assignee of the present invention. These devices are embodiments of U.S. patent applications Ser. Nos. 09/618,505, filed 18 Jul. 2000 and 09/678,271, filed 03 Oct. 2000, both of which are hereby incorporated by reference in their entireties. These transponders 10 are capable of interaction with Intermec's INTELLITAG interrogators and have been expounded upon in several commonly owned applications, such as U.S. patent application Ser. Nos. 10/125,786 and 10/125,783, both filed 18 Apr. 2002, both of which are hereby incorporated by reference in their entireties. The ONETAG and the MICROINSERT embody both an active and a passive sort of transponder, and both types are contemplated for use in the present invention.

Tabs 16 and 18 may be made from a conductive material, and may be communicatively coupled to the chip 14 such that one tab 16 forms a ground lead and one tab 18 forms a signal lead. To this end, chip 14 may have contact points or leads as is well understood. In an exemplary embodiment, the tabs 16, 18 form a dipole antenna at an operating frequency of approximately 2.45 GHz.

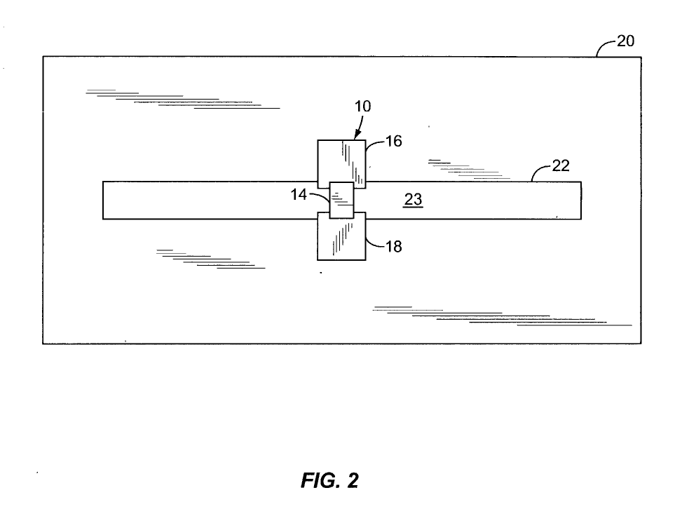

FIG. 2 illustrates the transponder 10 secured to a substrate 20 that delimits a slot 22. The substrate 20 may be of an appropriately conductive material such that slot 22 forms a slot antenna 23 when the tabs 16, 18 couple a signal to the slot 22. In an exemplary embodiment, the slot antenna 23 operates at approximately 915 MHz. In addition to the previously incorporated applications, reference is further made to U.S. Pat. No. 4,975,711, which is hereby incorporated by reference in its entirety, for more information about slot antennas.

In an exemplary embodiment, the tabs 16, 18 are secured to the substrate 20 with an adhesive having a defined melting point. The transponder 10 is applied at a temperature below the melting point. If, at any time, the temperature exceeds the threshold of the melting point, the transponder 10 detaches and no longer couples to the slot 22. Exemplary adhesives with defined melting points are described in U.S. Pat. Nos. 6,403,222; 6,368,707; and 6,350,791, which are hereby incorporated by reference in their entireties.

When the transponder 10 is coupled to the slot 22, the transponder 10 operatively responds at the frequency of the slot antenna 23, effectively operating in a first mode. When the transponder 10 is not coupled to the slot 22, the transponder 10 responds at the frequency of the dipole antenna formed by the tabs 16, 18, effectively operating in a second mode. Interrogation of the transponder 10 determines in which mode the transponder 10 is operating and provides an indication as to whether the container being monitored has been exposed to a temperature over the predetermined threshold and for a sufficient amount of time for the adhesive to reach its melting point. Depending on the type of adhesive used, the adhesive may melt when reaching a threshold temperature, or when reaching a threshold temperature and remaining there for a given amount of time.

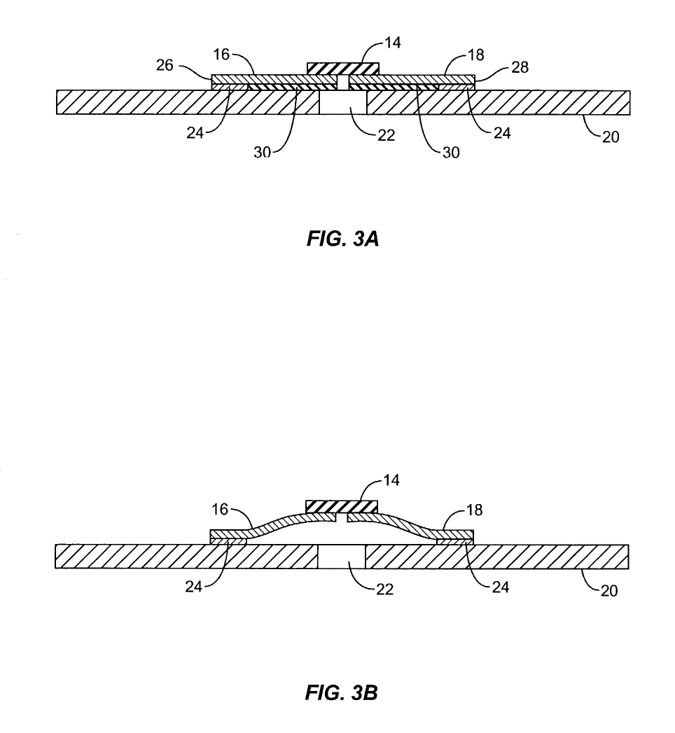

In an alternate embodiment, it may be desirable to keep the transponder 10 secured to the substrate 20 such that it remains affixed thereto after exceeding the predefined melting point of the adhesive, yet still remains capable of changing modes of operation when the predefined melting point has been exceeded. Such an alternate embodiment is illustrated in FIGS. 3A and 3B, wherein the transponder is secured by a second adhesive 24 at the terminal ends 26, 28 of the tabs 16, 18 respectively. The second adhesive 24 may comprise an adhesive with a melting point substantially higher than the melting point of the first adhesive 30 that is used in the embodiment of FIG. 2 and in the center portion of the embodiment of FIGS. 3A and 3B, or the second adhesive 24 may substantially not have a melting point, remaining adhesive throughout all normal operating temperatures.

In this embodiment, when the predefined melting temperature is exceeded, the first adhesive 30 melts and the tabs 16, 18 deform, lifting the chip 14 away from the slot 22 such that the chip 14 no longer couples to the slot 22, yet remains secured to the substrate 20 by the second adhesive 24. In the event that the tabs 16, 18 have a shape memory, it is possible to preform the tabs 16, 18 into a desired shape. When secured to the substrate 20, the tabs 16, 18 are deformed by the first adhesive 30 into a generally planar entity. When the first adhesive 30 melts, the tabs 16, 18 return to their original shape as dictated by the shape memory. The shape memory may be imparted by an inherent resilient feature of the tabs or other known shape memory technique. Soldering or other rigid securing process may replace second adhesive 24.

When the first adhesive 30 has melted, the transponder 10 operates at the operating frequency of the dipole antenna formed by the tabs 16, 18 and not at the operating frequency of the slot antenna 23 since the tabs 16, 18 are no longer coupled to the slot 22.

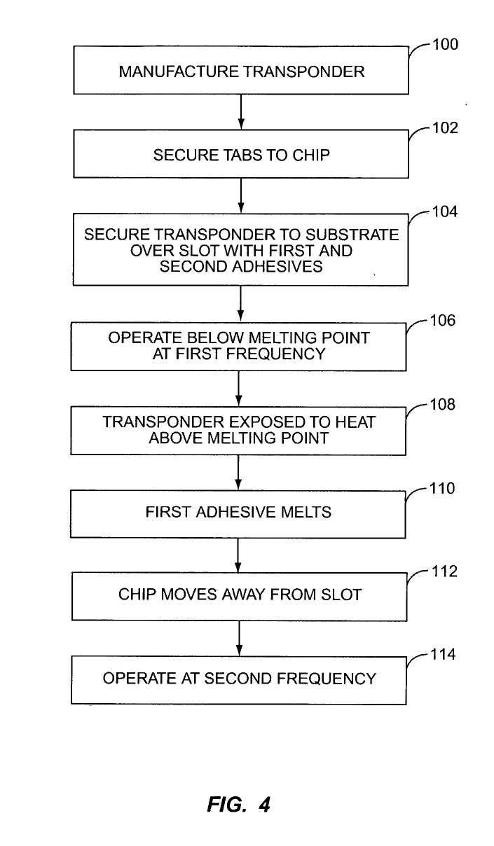

The present invention has a particular process which is better understood with reference to the flow chart of FIG. 4 wherein the attachment, exposure to temperature and decoupling is outlined. The transponder 10 is manufactured (block 100). During manufacturing, the tabs 16, 18 may be secured to the chip 14 (block 102). This may be done through a conventional soldering process or the like as needed or desired.

The transponder 10 is secured to the substrate 20 over the slot 22 with first adhesive 30 and second adhesive 24 (block 104). The chip 14 operates in conjunction with the slot 22 at a first frequency so long as the transponder 10 is maintained in an environment below the melting point (block 106). As previously explained, in an exemplary embodiment, this first frequency may be 915 MHz. As explained in the incorporated applications, the slot may be on a beer keg, a foil bag, or other container, and the transponder 10 may be secured for tracking purposes or the like.

At some point the transponder 10 may be exposed to enough heat to raise the ambient temperature surrounding the transponder 10 above the melting point of the first adhesive 30 (block 108). Exposure to the high temperature may be undesirable for any number of reasons, such as spoilage of food within the container of the substrate 20 or the like. The elevated temperature melts the first adhesive 30 (block 110), causing the chip.14 to move away and decouple from the slot 22 (block 112). This movement may be a complete disassociation of the transponder 10 from the substrate 20 as in the embodiment of FIG. 2, or it may be merely a deformation of the tabs 16,18 as in the embodiment of FIG. 3B. Since the chip 14 no longer couples to the slot 22, the chip 14 now operates at a second frequency as defined by the dipole formed by the tabs 16, 18 (block 114). As noted above, this second frequency may be 2.45 GHz. The change in operating frequency may be detected by first interrogating the transponder 10 at the first operating frequency, and if a response is not received, interrogating the transponder 10 at the second operating frequency. If a response is received at the first operating frequency, that response is an indication that the transponder 10 and the container it identifies have not been exposed to a temperature above the predetermined threshold. If however, a response is received at the second frequency, such a response is indicative that the container and the transponder 10 have been exposed to elevated temperatures.

The interrogator may be associated with a reporting system. This reporting system may be located in close proximity to the interrogator and may be coupled to the interrogator by either a wired or wireless connection. The reporting system may be a user interface or other computer system that is capable of receiving information about objects that contain the transponders 10 of the present invention. The information may be used to track the objects or to store information concerning the objects in the memory of the reporting system. The reporting system may further communicate information from the transponders 10 to a remote system. The communication between the reporting system and the remote system may be through wired communication, modem communication, or other networking communication, such as the Internet. Alternatively, the interrogator may communicate with the remote system directly rather than through the reporting system. Other variations are also possible.

Armed with the information either from the interrogator, the remote system, or the reporting system, an operator may cull containers or materials that have been exposed to too much heat, or otherwise act upon the knowledge that a transponder 10 has been exposed to a temperature above the predetermined melting point of the adhesive.

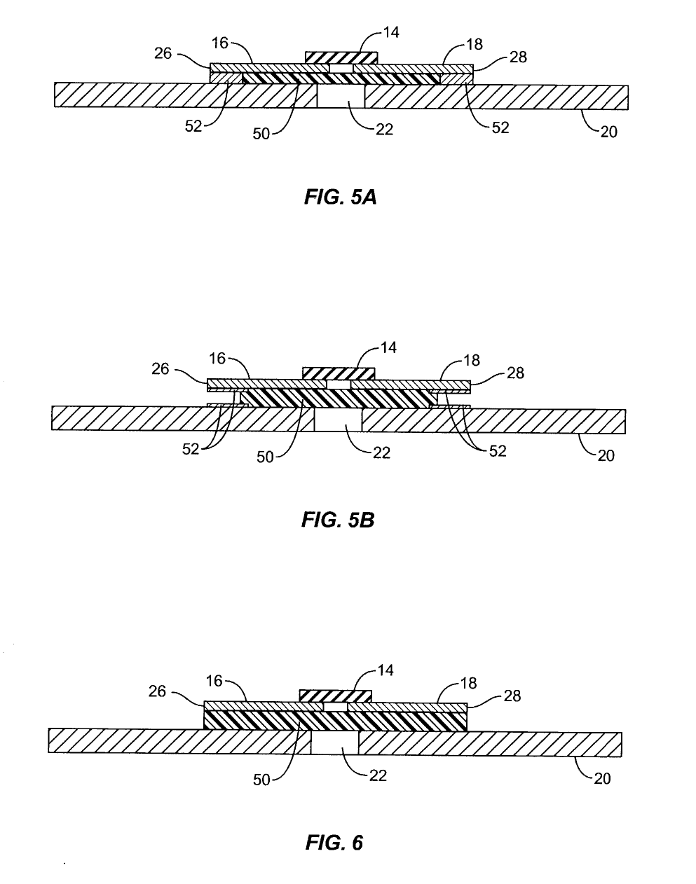

An alternate embodiment functions similarly in concept, but with attention paid to pressure rather than temperature. When the pressure falls below a predetermined threshold, the transponder 10 decouples from the substrate 20 and operates at a different frequency than when coupled. This is illustrated in FIGS. 5A, 5B, and 6.

The embodiment disclosed in FIGS. 5A and 5B is one in which a foam 50 or other resilient material is positioned between the substrate 20 and the tabs 16, 18. An adhesive 52 secures the tabs 16, 18 to the substrate 20. During normal pressure conditions, the transponder 10 is coupled to the slot 22 to form a slot antenna as the foam 50 is compressed. When a low pressure situation occurs, the foam 50 expands, as better illustrated in FIG. 5B. The force with which the foam 50 expands is sufficient in this embodiment to break the adhesive 52. Free of the adhesive bond, the transponder 10 is decoupled from the slot 22 and operates in a second mode with the tabs 16, 18 forming the operative antenna.

A second, related embodiment is illustrated in FIG. 6 wherein the foam 50 is secured to the tabs 16, 18 and the substrate 20 with an adhesive. Under normal pressure conditions, the foam 50 is compressed and the transponder 10 couples to the slot 22 to form a slot antenna. When a low pressure condition occurs, the foam 50 expands and decouples the transponder 10 from the slot 22, thereby causing the transponder to operate in the second mode, using the tabs 16, 18 as an antenna. This embodiment operates more as a threshold pressure sensor where continuous interrogation detects whether the pressure has fallen below the threshold needed to keep the foam 50 compressed enough to keep the transponder 10 coupled to the slot 22. In contrast, the embodiment of FIGS. 5A and 5B has a memory of sorts wherein interrogation after the rupture of the adhesive 52 detects whether the pressure has fallen below the threshold.

In both embodiments, it should be noted that the antenna formed by the tabs 16, 18 has a different operative frequency than the slot antenna 23. The pressure threshold will be set in both embodiments as a function of the material of the foam 50 and/or the strength of the adhesive 52. While foam is particularly contemplated, other resilient materials may also be used if needed or desired.

Armed with the information either from the interrogator, the remote system, or the reporting system, an operator may cull containers or materials that have been exposed to too little pressure, or otherwise act upon the knowledge that a transponder 10 has been exposed to a pressure below a predetermined melting point of the adhesive.

Those skilled in the art will recognize improvements and modifications to the preferred embodiments of the present invention. All such improvements and modifications are considered within the scope of the concepts disclosed herein and the claims that follow.

What is claimed is:

1. A transponder, comprising:
a wireless communication circuit;
at least one tab forming an antenna associated with the wireless communication circuit operative at a first frequency; and
a temperature sensitive adhesive associated with said at least one tab such that when exposed to a temperature above a predetermined threshold, the temperature sensitive adhesive melts.

2. The transponder of claim 1, wherein said at least one tab comprises a pair of tabs.

3. The transponder of claim 2, further comprising a slot functioning as a slot antenna operative at a second frequency, said tabs coupling the wireless communication circuit to said slot to form the slot antenna.

4. The transponder of claim 3, further comprising a substrate, said substrate delimiting said slot.

5. The transponder of claim 4, further comprising a second adhesive securing said tabs to said substrate even when said temperature sensitive adhesive has melted from exposure to a temperature above the predetermined threshold.

6. The transponder of claim 2, wherein said wireless communication circuit responds at a second frequency so long as the temperature sensitive adhesive has not been exposed to a temperature above the predetermined threshold and responds at the first frequency after the temperature sensitive adhesive has been exposed to a temperature above the predetermined threshold.

7. The transponder of claim 6, wherein said wireless communication circuit responds at the second frequency for a predetermined amount of time after the temperature sensitive adhesive has been exposed to the temperature above the predetermined threshold.

8. A method of wirelessly communicating information, comprising:
adhering the transponder to a substrate delimiting a slot with a temperature sensitive adhesive;
coupling the transponder to the slot to form a slot antenna;
communicating at a first frequency using the slot antenna; and
communicating at a second frequency when the transponder has been exposed to a temperature above a predetermined threshold that causes the temperature sensitive adhesive to melt, thereby decoupling the transponder from the slot.

9. The method of claim 8, wherein operating at a first frequency comprises operating at approximately 2.45 GHz.

10. The method of claim 8, wherein operating at a second frequency comprises operating at approximately 915 MHz.

11. The method of claim 8, further comprising additionally adhering the transponder to the substrate with a second adhesive substantially non-responsive to changes in temperature.

12. The method of claim 11, further comprising deforming tabs on the transponder when adhering the transponder to the substrate with the first and second adhesives.

13. The method of claim 12, further comprising allowing the tabs to return to an original shape after the temperature sensitive adhesive has melted.

14. The method of claim 11, wherein additionally adhering the transponder to the substrate with the second adhesive comprises adhering tabs on the transponder with the second adhesive proximate an endpoint on each of the tabs.

15. A system for determining if a transponder has been exposed to a temperature above a predetermined threshold, comprising:
a substrate delimiting a slot;
said transponder comprising a pair of tabs coupling the transponder to said slot to form a slot antenna operative at a first frequency;
said transponder secured to said substrate by a temperature sensitive adhesive such that exposure to a temperature above the predetermined threshold melts the temperature sensitive adhesive, decoupling the transponder from the slot and causing the tabs of the transponder to act as an antenna at a second frequency.

16. The system of claim 15, wherein the first frequency is operative at approximately 2.45 GHz.

17. The system of claim 15, wherein the second frequency is operative at approximately 915 MHz.

18. The system of claim 15, wherein a second adhesive further secures the tabs to the substrate such that the transponder is still secured to the substrate after the temperature sensitive adhesive melts.

19. A transponder, comprising:
a wireless communication circuit;
at least one tab forming an antenna associated with the wireless communication circuit operative at a first frequency; and
a resilient material associated with said at least one tab such that when exposed to a pressure below a predetermined threshold said resilient material expands.

20. The transponder of claim 19, wherein said at least one tab comprises a pair of tabs.

21. The transponder of claim 20, further comprising a slot functioning as a slot antenna operative at a second frequency, said tabs coupling the wireless communication circuit to said slot to form the slot antenna.

22. The transponder of claim 21, further comprising a substrate, said substrate delimiting said slot.

23. The transponder of claim 19, further comprising an adhesive adapted to secure said at least one tab to a substrate and further adapted to be disrupted when said resilient material expands due to exposure to a pressure below a predetermined threshold.

24. The transponder of claim 20, wherein said wireless communication circuit responds at a second frequency if the resilient material has been exposed to a pressure below the predetermined threshold.

25. A method of wirelessly communicating information, comprising:
securing the transponder to a substrate delimiting a slot with a resilient material;
coupling the transponder to the slot to form a slot antenna;
communicating at a first frequency using the slot antenna; and
communicating at a second frequency when the transponder has been exposed to a pressure below a predetermined threshold that causes the resilient material to expand, thereby decoupling the transponder from the slot.

26. The method of claim 25, wherein operating at a first frequency comprises operating at approximately 2.45 GHz.

27. The method of claim 25, wherein operating at a second frequency comprises operating at approximately 915 MHz.

28. The method of claim 25, further comprising additionally adhering the transponder to the substrate with an adhesive adapted to be disrupted when said resilient material expands.
